(19) United States
(12) Patent Application Publication
(10) Pub. No.: US 2010/0011040 A1
(43) Pub. Date: Jan. 14, 2010

(54) Device and method for solving a system of equations characterized by a coefficient matrix comprising a Toeplitz structure

(76) Inventor: James Vannucci, McDonald, PA (US)

Correspondence Address: James Vannuccl, 5212 Forest View Drive, McDonald, PA, 15057, US

(21) Appl. No.: 12/453,078

(22) Filed: Apr. 29, 2009

Related U.S. Application Data
(63) Continuation-in-part of application No. 12/218,052, filed on Jul. 11, 2008.

(51) Int. Cl. G06F 17/14; G06F 7/52

(52) U.S. Cl. 708/400; 708/607

(57) ABSTRACT

A device comprising digital circuits for calculating an unknown solution vector X in a system of equations with a known coefficient matrix T and a known vector Y, has a first vector transformer for calculating a transformed known vector Yt from said known vector Y, and a second vector transformer for calculating said unknown solution vector X from a transformed unknown solution vector Xt; a system solver comprising means for calculating said transformed unknown solution vector Xt from elements contained in a matrix Ttapp, and from elements contained in said transformed known vector Yt; a matrix separator for calculating a plurality of matrices C from said coefficient matrix T, and for calculating a plurality of transformed matrices Ct by calculating matrix products that comprise a transform matrix F and each of said plurality of matrices C; and a coefficient matrix transformer comprising means for calculating said matrix Ttapp from said plurality of transformed matrices Ct.

### CROSS-REFERENCE TO RELATED APPLICATIONS

This application is a Continuation-in-Part of U.S. Ser. No. 12/218,052, filed on Jul. 11, 2008, the entire contents of which are incorporated herein.

### BACKGROUND OF THE INVENTION

The present invention relates to the field of signal processing. In particular, the present invention concerns devices and methods for solving a set of equations with a coefficient matrix [T] comprising a Toeplitz structure.

Many communications devices require the solution of a system of equations, usually in the form of [T][X]=[Y], having an approximately Toeplitz or an approximately block Toeplitz coefficient matrix [T]. These devices can be used for carrier frequency correction, speech encoding, communications channel estimation, mitigating intersymbol interference, the cancellation of echo and noise, channel equalization, and user detection. Toeplitz and approximately Toeplitz matrices frequently appear also in the algorithms of many imaging and sensing devices.

In many of these applications, a Toeplitz matrix may be substituted for an approximately Toeplitz matrix without a significant effect on the solution, or with only a relatively small number of extra calculations required to obtain a satisfactory solution.

Replacing all the elements along a diagonal of an approximately Toeplitz matrix with the average of the elements along that diagonal results in a good approximate solution for many problems. Jansson et al (U.S. Pat. No. 5,153,926) and Ding (US 2006/0039458 Al). Barnard (U.S. Pat. No. 6,545,639) discloses replacing a covariance matrix in a radar/sonar sensor array system with a Toeplitz matrix whose elements along a diagonal are the least squares approximation of the elements along a diagonal of the covariance matrix. Hui (US 2005/0276356) discloses iteratively calculating the inverse of an approximately Toeplitz matrix from the inverse of a Toeplitz matrix.

Many algorithms already exist for solving a Toeplitz system of equations. These algorithms are extensively documented in the prior art and so will only be very briefly summarized here. These algorithms can generally be classified as either direct or iterative algorithms with the direct algorithms being further sub-classified as classical, fast or super fast algorithms, depending on the number of steps required for a solution of the system of equations they represent.

The most popular iterative methods include algorithms from the conjugate gradient family of algorithms. Classical direct methods require O(n³) computational steps, and include Gauss elimination, and Cholesky decomposition. The classical direct methods do not take advantage of the displacement structure of the matrices. Fast direct methods take advantage of the displacement structure of matrices and require O(n²) steps. Examples of these algorithms include the Levinson type algorithms, and the Schur type algorithms. Super fast direct methods are relatively new, and require O(n(log n)²) steps.

Iterative methods can be fast and stable, but can also be slow to converge for some systems. The classical direct methods are stable, but are slow. The fast direct methods are stable and fast. The super fast direct methods have not been shown to be stable, and many are only asymptotically super fast. As such, there is a need for devices and methods for solving a set of equations with a coefficient matrix [T] comprising a Toeplitz structure that implement stable algorithms which give superior performance, and which can be easily implemented on parallel computing architectures.

### SUMMARY OF THE INVENTION

The present invention solves the above and other problems in providing a device and a method for solving a set of equations with a coefficient matrix [T] comprising a Toeplitz structure, wherein the solution to this system of equations is obtained by transforming the [T] matrix into a narrow band dominant transformed matrix. This transformed matrix is then approximated by a banded matrix [Ttapp]. This allows the resulting system of equations to be solved in a very efficient manner.

The Toeplitz structure of a matrix [T] can be exploited to form a set of transform matrices that can transform the [T] matrix into a narrow band dominant form. A given [T] matrix can be separated into a sum of products comprising matrices [Ci] and diagonal matrices [Dni]. Each of the transform matrices are the product of two matrices. One matrix transforms the [Ci] matrices to a diagonally dominant matrix, the other matrix assists in transforming the remaining portion of the [T] matrix to a band dominant form. Matrix elements not in selected bands of the transformed result are set to zero to obtain an efficiently solved system of equations with an approximate banded coefficient matrix. To improve the accuracy of the approximation, the outer rows and columns of the [T] matrix can be modified, and the [T] matrix can be extended to a larger dimension. Modifying and extending the [T] matrix introduces extra unknowns into the system of equations.

### DRAWINGS

FIG. 1(a) shows a Toeplitz matrix expanded in terms of the quotient of sine and cosine functions.

FIG. 1(b) shows a system of equations with pad and modified rows and columns.

FIG. 1(c) shows matrices that can be used to form Toeplitz matrices.

FIGS. 2(a) to 2(f) are diagrams of the device components used to solve a system of equations with an approximate Toeplitz and block Toeplitz form.

FIGS. 3(a) to 3(b) show the form of the transformed system of equations.

FIG. 3(c) shows the form of the solution vector for a special type of coefficient matrix.

FIGS. 4(a) and 4(b) are diagrams of the device components used to solve a slowly-varying system of equations.

### DETAILED DESCRIPTION

Matrices that comprise a Toeplitz structure are matrices that are approximately Toeplitz, that can be rearranged to a Toeplitz or an approximately Toeplitz form, that can be efficiently transformed to a Toeplitz or approximately Toeplitz form, or that contain any of these forms as submatrices. Approximately Toeplitz matrices are matrices that have diagonals where the elements in each diagonal are of approximately equal value.

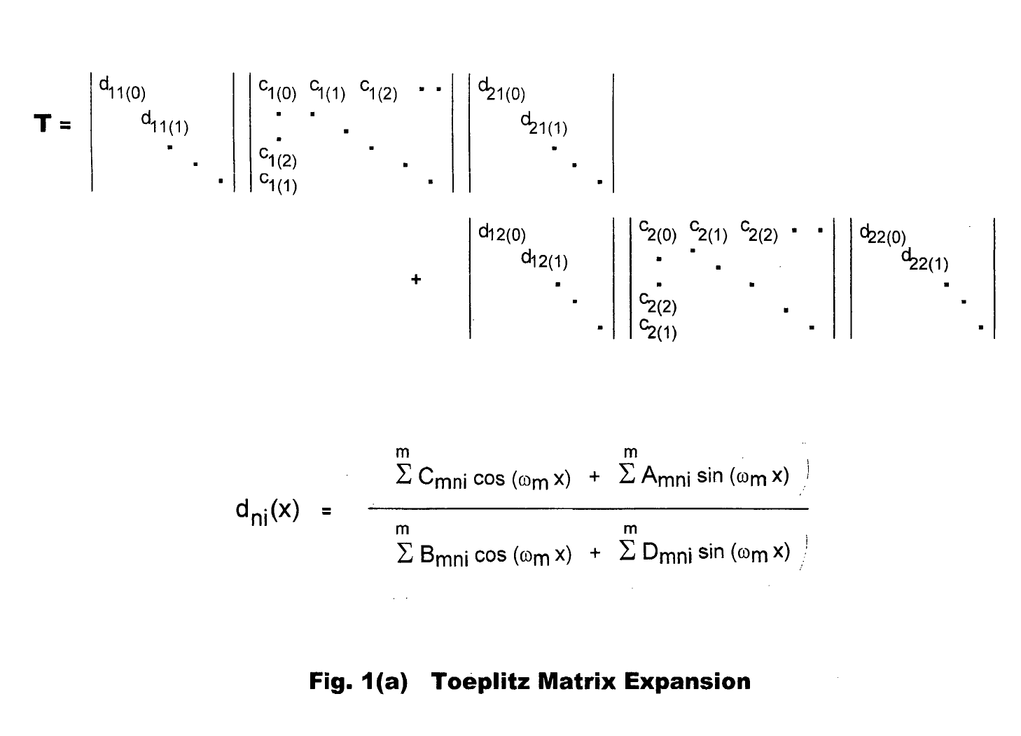

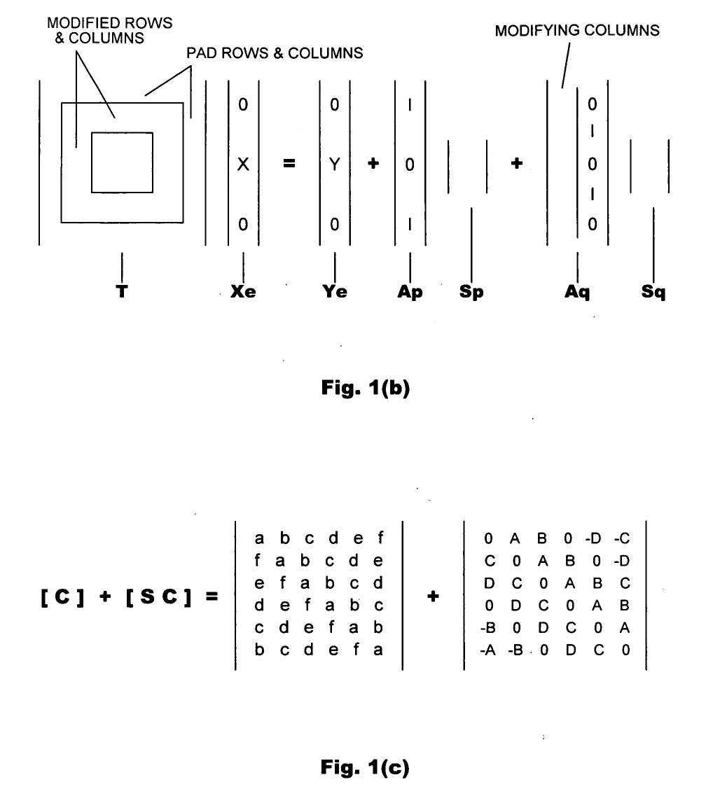

As shown in FIG. 1(a), a matrix [T] comprising a Toeplitz structure can be factored into a sum of components comprising the product of a matrix [Ci], which preferably is a circulant matrix, and known diagonal matrices [D1i] and [D2i], as shown below in equation (1).

$$\begin{matrix}[ T ] = {\sum }^{i} [ D 1 i ] [ Ci ] & D 2 i ]\end{matrix} \qquad ( 1 )$$

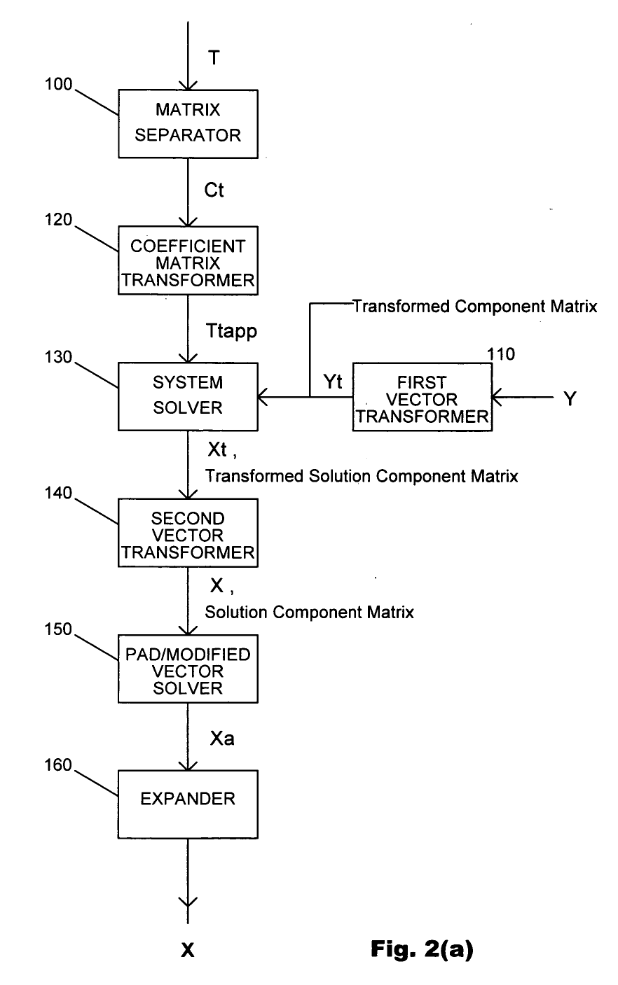

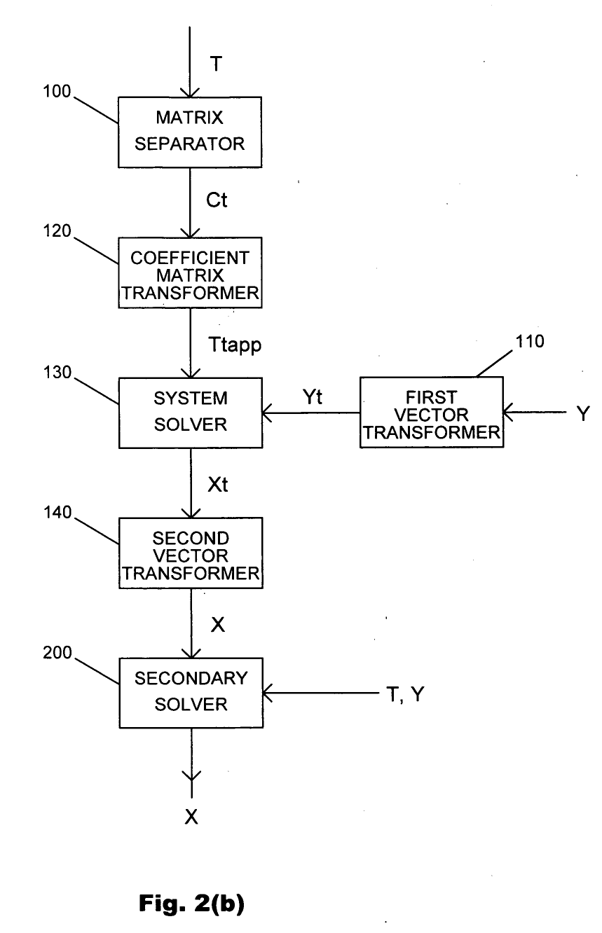

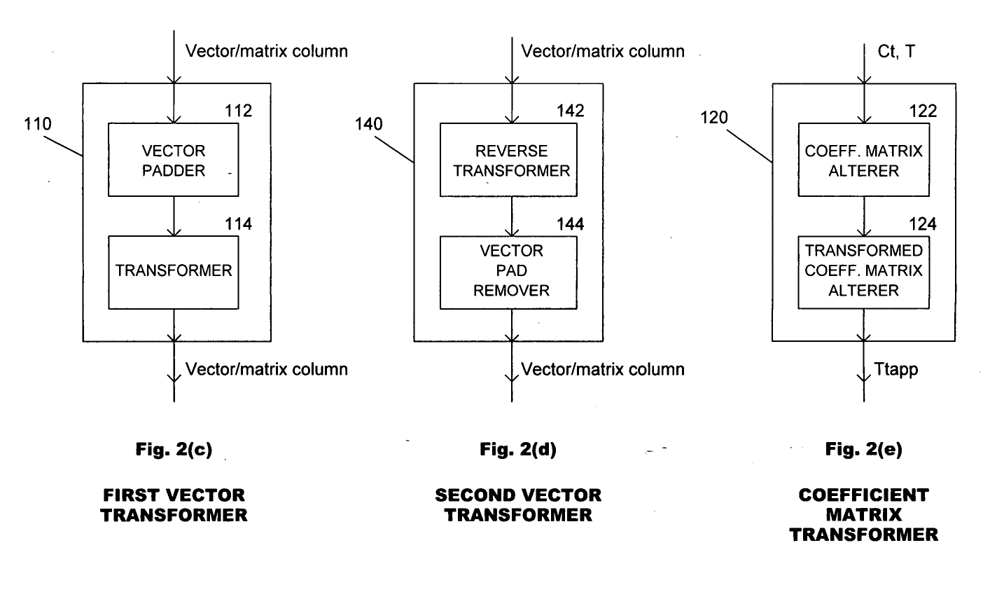

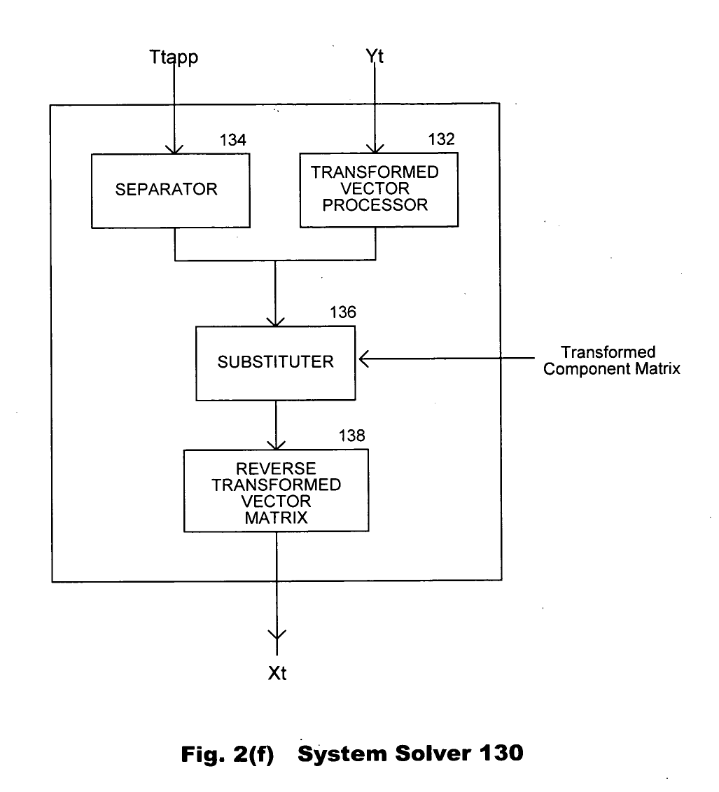

Referring to FIG. 2(a), a matrix separator 100 can be used to determine the value of the elements in the matrices [Ci] by solving equations resulting from the expression.

A quotient [U1i]/[L1i] can be substituted for the [D1i] diagonal matrix. A quotient [U2i]/[L2i] can be substituted for the [D2i] diagonal matrix. Both of these substitutions can be approximate substitutions. The [L1i], [L2i], [U1i] and [U2i] matrices are usually diagonal matrices, but can be diagonally dominant matrices. The [U1i] and [U2i] matrices are chosen such that when they are transformed by a selected transform they become banded or band dominant matrices.

If all of the matrices [L1i] are equal, and all of the matrices [L2i] are equal, then the matrices [L1i] and [L2i] can have any form when transformed by the selected transform. If the matrices [L1i] are not all equal, then the matrices [L1i] are chosen such that when they are transformed by the selected transform, they become banded or band dominant. If the matrices [L2i] are not all equal, then the matrices [L2i] are chosen such that when they are transformed by the selected transform, they become banded or band dominant. The transform of matrices [Ci] by the selected transform results in diagonal or diagonally dominant matrices.

The quotient [Uni]/[Lni] can be calculated by either of the products [inv Lni] [Uni], or [Uni] [inv Lni], where [inv Lni] is the inverse of the [Lni] matrix. Each of the transform matrices that are used to transform the [T] matrix can be factored into two matrices. One of these two matrices for each of the transform matrices form the selected transform that transforms the [Uni] and [Lni] matrices. The [Ci] matrices are also transformed by this selected transform. The matrix separator 100 can transform the [Ci] matrices, or a coefficient matrix transformer 120 can be used to calculate the transformed matrices [Cit].

$$[ T ] = {\sum }^{i} \frac{[ U 1 i ]}{[ L 1 i ]} [ Ci ] \frac{[ U 2 i ]}{[ L 2 i ]} \qquad ( 2 )$$

As a non-limiting example, the set of transform matrices can be defined as follows. The selected transform for this example is the Fourier transform.

$$[ Ft 1 ] = [ F F T ] [ {\prod }^{i} L 1 i ] \\ [ Ftr ] = [ {\prod }^{i} L 2 i ] [ inv F F T ] \\ [ rev Ft 1 ] = [ inv {\prod }^{i} L 1 i ] [ inv F F T ] \\ [ rev Ftr ] = [ F F T ] [ inv {\prod }^{i} L 2 i ] \qquad ( 3 )$$

The above products of the matrices [Lni] do not include duplicate [Lni] matrices. The matrix [FFT] is the fast Fourier transform. The matrix [inv FFT] is the inverse fast Fourier transform. The desired forms for the Fourier-transformed [L1i], [L2i], [U1i] and [U2i] matrices are obtained if the elements on the principal diagonals of the matrices [Uni] and [Lni] are approximated by the following expressions, for example.

$$[ Uni ] = {\sum }^{m} {A}_{mni} sin ( {w}_{m} x ) + {\sum }^{m} {C}_{mni} cos ( {w}_{m} x ) \\ [ Lni ] = {\sum }^{m} {B}_{mni} cos ( {w}_{m} x ) + {\sum }^{m} {D}_{mni} sin ( {w}_{m} x ) \qquad ( 4 )$$

These expressions determine the elements in the bands of the Fourier-transformed [Uni] and [Lni] matrices, and are usually chosen so that the quotient of the [Uni] matrix divided by the [Lni] matrix gives the best approximation of the principal diagonals of the matrices [D1i] and [D2i].

The [Uni] and [Lni] matrices can be modified by the addition of rows and columns either before or after they have been transformed. Modifying these matrices introduces additional unknowns to the system of equations.

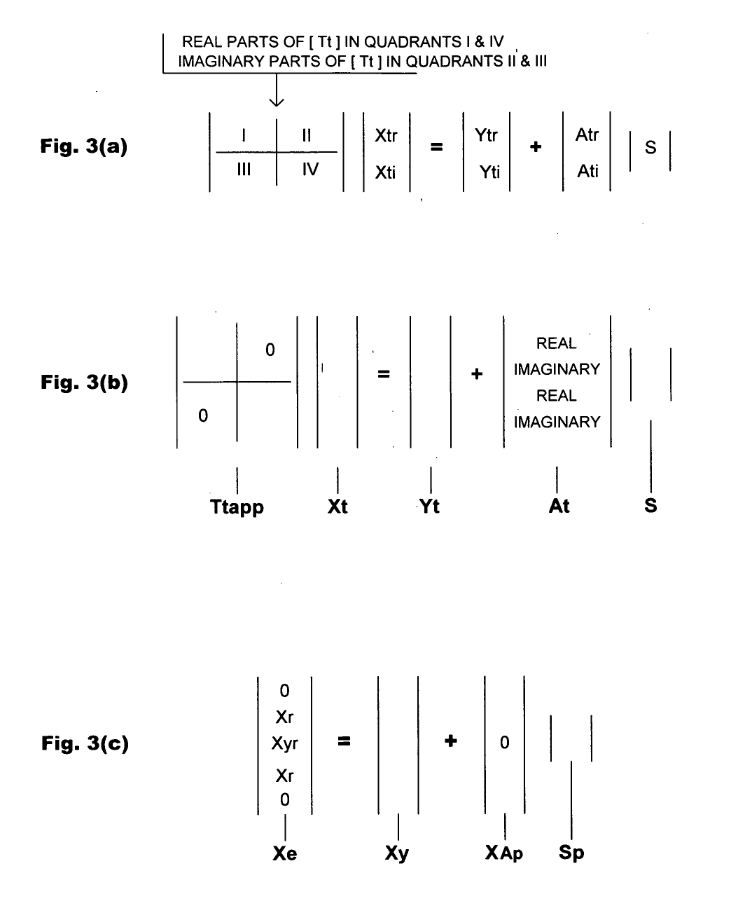

Application of the transform to the system of equations with the coefficient matrix [T] results in a band dominant matrix, as shown below in equation (5) and FIG. 3(a).

[Ft1][T][Ftr][rev Ftr][X]=[Ft1][Y] (5)

Again referring to FIG. 2(a), a first vector transformer 110 transforms any vector or column of a matrix. The first vector transformer 110 calculates the transformed vector [Yt] by calculating the product [Ft1] [Y]. A coefficient matrix transformer 120 calculates the transformed coefficient matrix, [Tt], by calculating the product [Ft1] [T] [Ftr]. The coefficient matrix can be altered to improve the solution characteristics of the system of equations. The alterations are performed by a coefficient matrix alterer 122, as shown in FIG. 2(e).

The coefficient matrix alterer 122 forms an extended matrix, [Te], by extending the diagonals of a [T] matrix to form a matrix of greater dimensions while approximately preserving the structure of the [T] matrix. The definition and use of a [Te] matrix improves the match between a [Dni] matrix and the principal diagonal of the quotient of a [Uni] matrix divided by an [Lni] matrix. Extending a [T] matrix into a [Te] matrix introduces additional unknowns, [Sp], as shown in FIG. 1(b).

[T][X]=[Y] (6)

[Te][Xe]=[Ye]+[Ap][Sp] (7)

The [Ye] and [Xe] vectors are the [Y] and [X] vectors with a zero pad. The first vector transformer 110 inserts the zero values into the [Y] vector before it calculates the transformed vector [Yt] in FIG. 2(c).

The coefficient matrix alterer 122 of the coefficient matrix transformer 120 forms a modified matrix, [Tm], by adding modifying rows and columns to already existing rows and columns of the [T] matrix. The use of a [Tm] matrix improves the match between a [Dni] matrix and the principal diagonal of a quotient of a [Uni] matrix divided by an [Lni] matrix. Usually, the modifying rows and columns are added to the first and last rows and columns of the [T] matrix. Modifying a [T] matrix also introduces additional unknowns.

A matrix [Tm] can be formed from a [Te] matrix and the product of two matrices [Bq] and [Aq]. The modified rows and columns of the [Te] matrix are usually the rows and columns that are near the periphery of the original [T] matrix. The matrix [Bq] includes modifying rows. The matrix [Bp] includes pad rows.

[Te][Xe]=[Ye]+[Ap][Sp] (8)

[Tm]=[Te]+[Aq][Bq] (9)

[Bq][Xe]=[Sq][Bp][Xe]=[Sp] (10)

These equations (8) to (10) can be used to calculate the matrix [Tm] once matrices [Aq] and [Bq] have been selected. The system of equations takes the form of equation (11) below, and as shown in FIG. 1(b).

[Tm][Xe]=[Ye]+[Aq][Sq]+[Ap][Sp] (11)

The matrix [Ap] contains non zero values for elements that correspond to pad rows added to the system of equations to form the extended matrix, [Te]. The matrix [Aq] contains non zero values for elements that correspond to modifying rows in the matrix [Tm]. The matrix [Aq] also contains the modifying columns that were added to the [Te] matrix.

The stability of the above disclosed methods may be improved by methods that are well known in the art including, but not limited to, the addition of white noise to the [T] matrix, diagonal loading of the [T] matrix, or preconditioning the [T] matrix.

A [T], [Tm] or [Te] matrix can be factored into the above-defining form of [Ci], [Uni], and [Lni] matrices by a number of different methods. These methods result in different values for the elements that make up the [Ci], [Uni] and [Lni] matrices.

The elements g(n) in the diagonal matrices, [D1i] and [D2i], respectively, can have the following relationship (12). Each diagonal matrix usually has a different g(n).

g(n+s)=g(n)g(s) (12)

This recursion relationship (12) can be used to select the elements in the diagonals of the [D1i] and [D2i] matrices. Once the diagonal matrices have been chosen, the values of the [Ci] matrices can be calculated. Well known values that satisfy the relationship for the terms contained in the diagonals of the [D1i] and [D2i] matrices are values given by exponential functions with real or imaginary arguments. The range of values for the constant in the argument of the exponential functions that specify the elements on the diagonal of the [D1i] and [D2i] matrices can be arbitrarily chosen.

The following example has values on the principal diagonals of the [D1i] and [D2i] matrices that re given by an exponential function with a real argument.

[Te]=[D11][C1][D21]+[D12][C2][D22] (13)

If the [T] matrix is symmetric, the following simplifications can be made.

[D11]=[D12]=[D1]; [D21]=[D22]=[D2]; [C1]=[C]; [C2]=[C*][Te]=[D1][C][D2]+[D2][C*][D1] (14)

Since the [Te], [D1] and [D2] matrices are all known, the elements of the [C] and [C*] matrices an be determined from the equations that constitute this matrix equality by the matrix separator 100. The matrix [D1] can be chosen to be a diagonal matrix with exponentially decreasing elements. The matrix [D2] can be chosen to be a diagonal matrix with exponentially increasing elements. The matrix [C] is a circulant matrix and the matrix [C*] is the transpose of the matrix [C]. The quotients [U1]/[L1] and [U2]/[L2] can be substituted for matrices [D1] and [D2]obtain the following expression.

[Te]=([U1]/[L1])[C]([U2]/[L2])+([U2]/[L2])[C*]([U1]/[L1]) (15)

If the [Te] matrix is a real Toeplitz matrix, the application of the transform matrices to the matrix [Te] is a real matrix if [D2] is chosen such that the FFT of [D2] is the complex conjugate of the FFT of [D1]. This choice requires a row and a column in the [Te] matrix to be padded or modified.

[Te]=([U1]/[L])[C]([U]/[L])*+([U]/[L])*[C*]([U]/[L]) (16)

In general, any function with a recursion relationship can be used to define the elements in the diagonal matrices. The recursion relationship maintains the Toeplitz form of the [Te] matrix when the [Te] matrix is expressed as the result of a sum of products of diagonal matrices and a circulant matrix.

A [Te] matrix can also be separated into components that have matrices [D1] and [D2] that both have diagonal elements given by exponential functions with imaginary arguments as their diagonal elements. The matrices [D1] and [D2] can be chosen such that the FFT of the [D2] matrix is the complex conjugate of the FFT of the [D1] matrix.

[Te]=[D][C][D*]+[D*][C*][D] (17)

[Te]=([U]/[L])[C]([U]/[L])*+([U]/[L])*[C*]([U]/[L]) (18)

A [Te] matrix can also be separated into the following form with matrices [D1] and [D2] having elements given by exponential functions with imaginary arguments.

[Te]=[C1]+[D1][C2][D2] (19)

The range of values for the imaginary arguments of the exponents in the diagonal terms of the diagonal matrices can be arbitrarily chosen for maximum performance.

Other forms for separated [Te] matrices can be obtained by factoring the above-disclosed equations. This can result in the principal diagonal of the [D] matrices containing elements whose values are given by sine and cosine functions. It can also result in a form where the [C] matrices are either symmetric circulant or asymmetric circulant.

A separated [Te] matrix can also be formed by separating the [Te] matrix into the sum of a matrix [SC] and a circulant matrix [C]. FIG. 1(c).

[Te]=[C]+[SC] (20)

The value of sin(k·i), where i is the row index x minus the column index y, is then factored out from each element in the matrix [SC].

[Te]=[C]+[S sin(k·i)] (21)

Two diagonal matrices are then factored out from the [S sin (k·i)] matrix term using the following recursion relationship. The value of k is arbitrary. The [S] matrix is circulant.

sin(k·i)=sin(k·x)cos(k·y)−cos(k·x)sin(k·y) (22)

[Te]=[C]+[sin(k·x)][S][cos(k·y)−[cos(k·x)][S][sin(k·y)] (23)

Substituting the quotient of diagonal matrices [Us]/[L] and [Uc]/[L], where [Us] is the sine expansion and [Uc] is the first cosine expansion, and [L] is a second cosine expansion, for the sine and cosine matrices, respectively, gives the following expression.

[Te]=[C]+([Us]/[L])[S]([Uc]/[L])−([Uc]/[L])[S]([Us]/[L]) (24)

In general, there are 0(n) equations that determine the values of the elements in the [C] and [S] matrices, and these equations usually have two to four terms. The matrix separator 100 uses these equations to calculate the values of the [C] and [S] matrices. The matrix separator 100 also calculates transformed matrices [Ct] and [St] for each [C] and [S] matrix by calculating the product of a FFT and the first column of each [C] and [S] matrix.

The Aₘₙᵢ, Bₘₙᵢ, Cₘₙᵢ and Dₘₙᵢ weight coefficients are usually different for each [Dni] matrix, and must be determined for each [Dni] matrix. They can be determined by using the matrix quotient [Uni]/[Lni] to approximately model the principal diagonal g(n)of the corresponding [Dni] matrix. The function g(n) designates the nth element on the diagonal of the specific [Dni] matrix. Elements of the [Dni] matrices that correspond to pad or modified rows and columns usually are not included in the modelling process. Usually, it is desirable to express the [Uni] and [Lni] matrices with the fewest number, and the lowest order, of terms.

Application of an iterative weighted least squares algorithm can result in an error distribution between the quotient [Uni]/[Lni] and the function g(n) that has most of the error occur in a small range of values for n, when n is small. This error disttribution permits the rows and columns associated with small values of n to be modified or padded. Pad and modified rows and columns remove the error for these rows and columns. The weight coefficients can be determined by solving a system of equations formed by partially differentiating the following equation with respect to each of the weight coefficients. The sum of the square of the error, err, is a constant.

$$\frac{{\sum }^{n} {( \begin{matrix}g ( n ) \cdot ( \begin{matrix}{\sum }^{m} {D}_{m} sin ( {w}_{m} n ) + \\ {\sum }^{m} {B}_{m} cos ( {w}_{m} n )\end{matrix} ) - \\ {\sum }^{m} {A}_{m} sin ( {w}_{m} n ) + {\sum }^{m} {C}_{m} cos ( {w}_{m} n )\end{matrix} )}^{2}}{Bp ( n )} = err \qquad ( 25 )$$

Here Bp(n) is a constant for each iteration and is initially unity for all values of n. For each subsequent iteration, the system of equations must be solved with updated values for Bp(n) based on the values from the previous iteration.

$$Bp ( n ) = {\sum }^{m} {D}_{m} sin ( {w}_{m} n ) + {\sum }^{m} {B}_{m} cos ( {w}_{m} n ) \qquad ( 26 )$$

The values of the weight coefficients can also be determined by taking the FFT of the [Dni] matrices and curve fitting the circulant result with a sum of matrices where each of the matrices has elements that are given by exponential functions with either real and/or imaginary arguments. Each of these matrices can then be decomposed into a quotient of a circulant [Um] matrix divided by circulant [Lm] matrix.

[Dapp]=[D1]+[D2]+[D3]+ (27)

[Dapp]=[U1]/[L1]+[U2]/[L2]+[U3]/[L3]+ (28)

[Dm]=[Dapp]+residue (29)

The matrix [Dm] or [Dapp] can be substituted into any one of the above-disclosed expressions for a diagonal matrix. Each [Um] and [Lm] is a banded matrix with a bandwidth of one. Curve fitting routines and methods are well known in the prior art.

Other regression methods, including nonlinear regression methods, can be used to determine the weight coefficients, and the desired distribution for err(n). The desired distribution can include a distribution that minimizes the magnitude of the elements that are not included within a specified bandwidth of the transformed [Uni] and [Lni] matrices. The g(n) function can be approximately expanded as follows.

$$g ( n ) = \frac{{\sum }^{m} {A}_{m} sin ( {w}_{m} n ) + {\sum }^{m} {C}_{m} cos ( {w}_{m} n )}{{\sum }^{m} {D}_{m} sin ( {w}_{m} n ) + {\sum }^{m} {B}_{m} cos ( {w}_{m} n )} + err ( n ) \qquad ( 30 )$$

Once the weight coefficients are determined for each of the [Dni] matrices, values for the quotients of a [Uni] matrix divided by a [Lni] matrix are calculated for elements that correspond to pad, and modified, rows and columns. These calculated values are substituted for the original values in each of the [Dni] matrices that correspond to the pad, and modified, rows and columns. These calculated values also determine the values for the pad, and modified, rows and columns. This reduces the magnitude of any nonzero values outside of the desired bands in the transformed [Uni] and [Lni] matrices. The expansion functions are not limited to trigonometric functions.

The transformed coefficient matrix alterer 124 shown in FIG. 2(e) is a component of the coefficient matrix transformer 120 that performs a number of functions to place the transformed coefficient matrix [Tt] in a banded form. These functions include changing the values of elements in the bands of the Fourier-transformed matrices [Uni] and [Lni] for improved solution characteristics, and rearranging rows and columns of the transformed coefficient matrix [Tt] as necessary to place [Tt] into a single banded form. FIG. 3(b).

A real transformed coefficient matrix [Tt] can take the form of a band dominant matrix with a band around the principal diagonal, and bands on the diagonals furthermost from the principal diagonal. The transformed coefficient matrix alterer 124 can rearrange rows and columns of this [Tt] matrix to obtain two systems of equations of half dimensions each with a single band around the principal diagonal.

The matrices [Ap] and [Aq] can be combined to form a single matrix [A]. The matrices [Atr] and [Ati] are the real and imaginary components of the transformed component matrix [At]. The vector [S] includes the vectors [Sp] and [Sq]. The vectors [Xtr], [Ytr], [Xti] and [Yti] are the real and imaginary components of the transformed vectors [Xt] and [Yt], as shown in FIG. 3(a).

A complex transformed coefficient matrix [Tt] can be factored into a band dominant matrix with five bands. The five bands may be reduced to a single band by the transformed coefficient matrix alterer 124. In the process, the complex transformed vector [Xt] is placed into a shuffled form comprising the magnitude of its real and imaginary unknowns. The complex transformed vector [Yt] is placed into a shuffled form comprising the magnitude of its real known values and imaginary known values by a component of the system solver 130 called the transformed vector processor 132, as shown in FIG. 2(f). The system solver 130 also comprises a reverse transformed vector processor 138 for un-shuffling, and obtaining the complex transformed vector [Xt] in un-shuffled form.

The transformed coefficient matrix alterer 124 approximates the band dominant transformed matrix [Tt] with a transformed approximate banded matrix [Ttapp]. This matrix [Ttapp] comprises matrices that are Fourier-transformed matrices [Cit], [Unit] and [Lnit]. This approximation comprises ignoring elements in Fourier-transformed [Uni] and [Lni] matrices that are outside a selected bandwidth, or ignoring and modifying selected elements in the transformed matrix [Tt] that are not in a selected band. Off-diagonal elements in the Fourier-transformed [Cit] matrices may also be set to zero. The matrix [Ttapp] can be reverse-transformed to an approximate coefficient matrix [Tapp].

The system solver 130 uses any methods known in the art to solve the system of equations with either the transformed coefficient matrix [Tt], or the transformed approximate banded matrix [Ttapp], as the coefficient matrix. Usually, the most efficient solution is obtained when the system of equations has the [Ttapp] matrix as the coefficient matrix. The system solver 130 includes components to implement the methods to solve these systems of equations, and obtain the transformed solution vector [Xt]. These components include a gausser for solving the banded system of equations by Gauss elimination, a separator 134 for separating the transformed coefficient matrix into a product comprising an upper banded matrix and a lower banded matrix, a transformed vector processor 132, a reverse transformed vector processor 138, and a substituter 136 for performing forward and backward substitution on a vector, and columns of transformed component matrices, as shown in FIG. 2(f).

The unknown vectors [Sp] and [Sq] are determined by a pad/modified vector solver 150 shown in FIG. 2(a). The transformed system of equations is given by the following expression. The products [Ft1] [Ap] and [Ft1] [Aq] are transformed component matrices.

$$[ Ft 1 ] [ Tm ] [ Ftr ] [ rev Ftr ] [ Xe ] = [ Ft 1 ] [ Ye ] + [ Ft 1 ] [ Ap ] [ Sp ] + [ Ft 1 ] [ Aq ] [ Sq ] \qquad ( 31 )$$

As a nonlimiting example, a symmetrix Toeplitz coefficient matrix [T] can have the following form when transformed and altered.

[Ttapp]=[Ut][Ct][U*t]+[U*t][C*t][Ut] (32)

The transformed matrices [Ut], [Ct] and [U*t] are transformed by a Fourier transform. An asymmetric Toeplitz coefficient matrix [T] can have the following form when transformed and altered.

[Ttapp]=[Ut][C1t][U*t]+[U*t][C2t][Ut] (33)

The transformed solution vector is given by the following expressions (34) and (35).

[Xt]=[Xyt]+[Xapt][Sp]+[Xaqt][Sq] (34)

[Xt]=[rev Ftr][Xe] (35)

The matrices [Xapt] and [Xaqt] can be combined to form a transformed solution component matrix. The [Sp] and [Sq] vectors are defined by the following equations.

[Bqt][Xt]=[Sq], [Bpt][Xt]=[Sp] (36)

The pad/modified vector solver 150 can determine the values of the [Sp] and [Sq] vectors by solving the following equations simultaneously. These equations can also be reverse transformed by the second vector transformer 140, shown in detail in FIG. 2(d), and solved.

([I]−[Bqt][Xaqt])[Sq]=[Bqt][Xyt]+[Bqt][Xapt][Sp]

([I]−[Bpt][Xapt])[Sp]=[Bpt][Xyt]+[Bpt][Xaqt][Sq] (37)

If there are no modified rows and columns, the pad/modified vector solver 150 can determine the [Sp] values from the following expression for the pad row portion of the [Xe] vector. This equation is obtained after the second vector transformer 140 reverse-transforms the above expression for [Xt]. The matrix [Xap] is a solution component matrix.

[0]=[Xy]+[Xap][Sp] (38)

The pad/modified vector solver 150 can determine the vector [Sp] from this equation. Once the values of the [Sp] and [Sq] vectors have been determined, the pad/modified vector solver 150 calculates their contribution to the values of the [Xe] or the [Xt] vectors.

The pad/modified vector solver 150 can also reduce the number of steps required to calculate the unknown values in the [S] vectors by approximately calculating particular values of either of the [Sp] or [Sq] vectors in terms of other values in the [Sp], [Sq] and [Y] vectors. This may be possible for systems in which the [T] coefficient matrix and the known vector [Y] have elements whose values are smoothly varying.

Referring to FIG. 2(b), a secondary solver 200 can eliminate elements of the [Ap] matrix from the system of equations even though their corresponding pad rows are included in the extended coefficient matrix [Te], as shown in FIG. 3(c).

The [Ap] matrix has the form of the first p+1 and last p columns of the identity matrix. If the inverse of the coefficient matrix [Tapp] has a form such that the magnitude of the elements in the inverse of the [Tapp] matrix rapidly decrease the farther they are positioned from the principal diagonal, then the product of the inverse of the [Tapp] matrix and the [Ap] matrix can be pproximated as a banded matrix for its upper most and lower most portions. Between this upper most portion and lower most portion there may only be a very small contribution to the final solution from the [Xap] matrix.

[Xe]=[Yt]+[Xap][Sp] (39)

The middle portion of the [Xe] vector, [Xyr], can be calculated without the use of the [Ap] matrix. Only the [Ye] vector needs to be processed for these values. Once this is done, a product of the [T] matrix and the [Xyr] vector can be computed and subtracted from the [Ye] vector leaving the following equation to determine the remaining unknown values of the [Xe] vector, [Xr]. The matrix [t] includes portions of the p to r+p rows and columns, and the n−p to n−r−p rows and columns, of the [Te] matrix. The vector [Xr] is the p to r+p and n−p to n−r−p rows of the [Xe] vector.

[y]=[T][Xyr] (40)

[t][Xr]=[Y]−[y] (41)

The [t] matrix is block Toeplitz with greatly reduced dimensions. This set of equations can be efficiently solved by the secondary solver 200 with methods disclosed herein for block [T] matrices.

An expander 160 can be used to calculate the solution to the original system of equations with the [T] coefficient matrix from the solution to the system of equations with an approximate coefficient matrix [Ta] by matrix expansion. The difference matrix [d] is the [T] matrix minus the [Ta] matrix. The following matrix expansion produces a sum of terms that are the product of the [T] matrix and the inverse of the [Ta] matrix. The vector [Xa] is approximately equal to the vector [X].

[T][X]=[Y]

[Ta][Xa]=[Y]+[Aq][Sq]

[Ta][inv Ta][T][X]=[Y]

[T]=[Ta]+[d]

[inv Ta][T]=[inv Ta]([Ta]+[d])=[I]+[inv Ta][d]

[Ta]([I]+[inv Ta][d])[X]=[Y]

([I]+[inv Ta][d])[X]=[Xa]

[X]=([I]−[inv Ta][d]+−)[Xa] (42)

The [Ta] matrix is a submatrix of a [Tapp] matrix and can be expanded to a [Tapp] matrix to efficiently calculate the above terms. If applicable, new values for the [Sp] and [Sq] vectors may need to be calculated.

The expander 160 can also obtain an update by taking the initial solution to the system of equations with the [Tapp] coefficient matrix, and using it as the solution to the original matrix equation. The vectors [Ye], [Yae], [Xae] and [Xue] are zero padded. The vectors [Xa] and [Ya] are approximately equal to the vectors [X] and [Y], respectively.

[T][X]=[Y]

[Tapp][Xae]=[Ye]+[A][S]

[T][Xa]=[Ya] (43)

The difference between the vectors [Y] and [Ya] is padded and used as the new input vector for the matrix equation with the [Tapp] coefficient matrix.

[Tapp][Xue]=[Ye]−[Yae]+[A][Su] (44)

The vector [Xu] is an iterative refinement to the vector [Xa]. This process can be repeated with each refinement bringing the result closer to the actual values of the vector [X]. The refinements require very few mathematical operations since backward and forward substitution has been performed on the [At] matrix, and the result stored in memory. Most of the required calculations are concerned with performing backward and forward substitution on the new vector [Ye]−[Yae] and solving for the [Su] vector values.

The expander 160 can also use the solution to the system of equations represented by the [Tapp] coefficient matrix as an initial solution vector estimate for other iteration techniques. Many such iteration techniques are known in the prior art, including methods from the conjugate gradient method family of iterative methods.

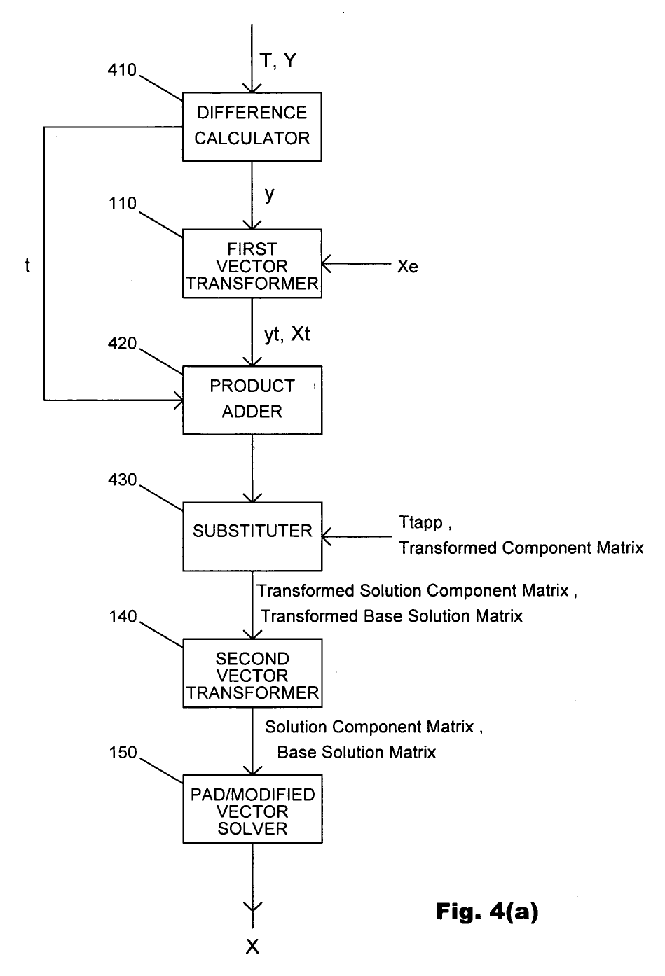

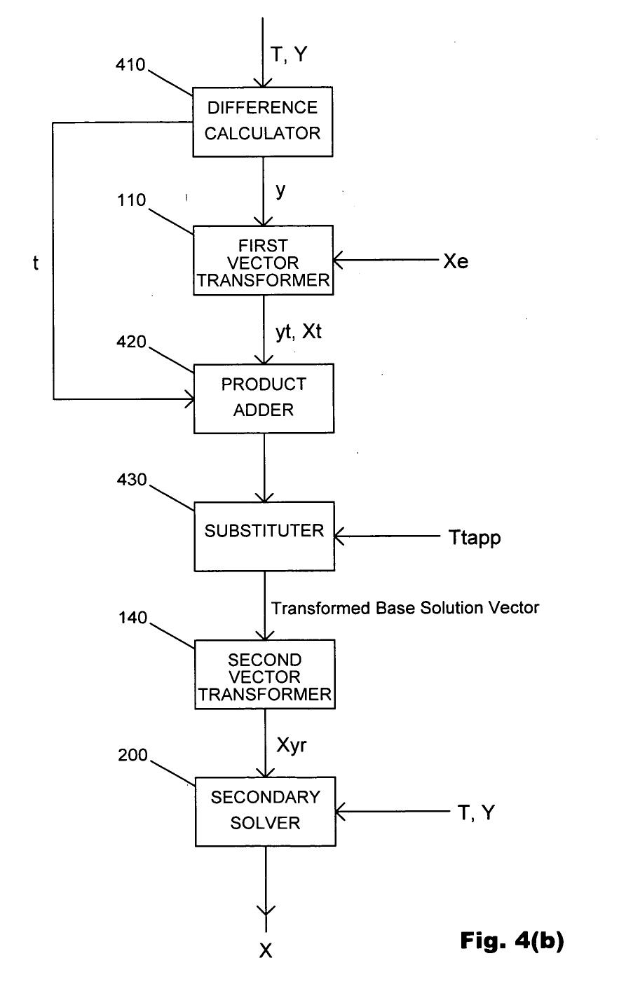

Referring to FIG. 4(a), if a system of equations with a coefficient matrix [T] that changes slowly with time is solved, an update to the solution at a later time can be efficiently calculated. The [Ap] and [Aq] fields have been condensed into a single field [A].

[T][X]=[Y]

[Ta][Xa]=[Y]+[Aq][Sq]

[Tapp][Xae]=[Ye]+[A][S] (45)

Changes in the system of equations are represented by a difference coefficient matrix [t], a difference vector [y] and vectors [s] and [x]. The matrix [t] is calculated from the difference between a subsequent matrix [T] and an initial matrix [Ta]. The vector [y] is calculated from the difference between a subsequent and initial known vector [Y]. Both of these terms are calculated by a difference calculator 410. Ignoring second order terms, the equation takes the following form. The vectors [x] and [y] are zero padded.

[Tapp][x]=[y]−[t][Xe]+[A][s]

[x]=[inv Tapp]([y]−[t][Xe]+[A][s])

([I]−[B][inv Tapp][A])[s]=[B][inv Tapp]([y]−[t][Xe]) (46)

A substituter 430 performs forward and backward substitution on both the transformed [y] vector and the transform of the matrix product [t] [Xe] to obtain a transformed base solution vector. The [s] update is easily calculated by a pad/modified vector solver 150.

The product of the [t] matrix and the [Xe] column vector can be easily computed, and added to the other terms by a product adder 420 since the [t] matrix is Toeplitz, or approximated by a Toeplitz matrix. Any new matrix products between the matrices [A] and [B] and other vectors are easily calculated since these matrices only have a few rows or columns. The term ([I]−[B] [inv Tapp] [A] ) is calculated and separated beforehand and stored in memory for use with each new set of update values. The solution component matrix is previously calculated from the product of the matrices [inv Tapp] and [A]. If changes in the [T] matrix can be ignored, the [t] matrix can be set to zero.

[x]=[inv Tapp]([y]+[A][s]) (47)

([I]−[B][inv Tapp][A])[s]=[B][inv Tapp][y] (48)

Referring to FIG. 4(b), a secondary solver 200 as disclosed above can also be implemented with a slowly varying coefficient matrix. The [Xyr] vector can be calculated by the following equation, and is an update to the middle portion of the [X] vector.

[Xyr]=[inv Tapp]([y]−[t][Xe]) (49)

The [Xr] vector is determined from a system of equations with a coefficient matrix formed from portions of the [T] matrix. If the above methods do not produce a useable result, a new initial solution to the system of equations must be obtained.

The above disclosed methods can be applied to a system of equations with a block coefficient matrix, [Tb]. The submatrices [Ts] are Toeplitz and can each be separated, altered, transformed, and rearranged by any of the above applicable methods into a banded matrix. Four or more terms comprising [C], [U] and [L] matrices may be needed for this separation. Pad and modified rows and columns may also be used in each submatrix. The dimensions of the submatrices [Ts] are Ns×Ns. The dimensions of the block matrix [Tb] are N×N. There is no limit to the number of submatrices.

$$[ Tb ] [ X ] = [ Y ] + [ A ] [ S ] \\ [ Tb ] = \begin{matrix}\vert & T 0 & T 1 & T 2 & \vert \\ \vert & T 3 & T 4 & T 5 & \vert \\ \vert & T 6 & T 7 & T 8 & \vert\end{matrix} \qquad ( 50 )$$

If the submatrices are symmetric, the coefficient matrix can be factored into the sum of two terms. The submatrices [Cn] and [D] are of dimensions Ns×Ns.

$$\begin{matrix} [ Tb ] = [ Db ] [ C ] [ {Db}^{*} ] + [ {Db}^{*} ] [ {C}^{*} ] [ Db ] & ( 51 ) \\ [ Db ] [ C ] [ {Db}^{*} ] = \begin{matrix}\vert & [ D ] & & & \vert \\ \vert & & [ D ] & & \vert \\ \vert & & & [ D ] & \vert\end{matrix} \begin{matrix}\vert & C 0 & C 1 & C 2 & \vert \\ \vert & C 3 & C 4 & C 5 & \vert \\ \vert & C 6 & C 7 & C 8 & \vert\end{matrix} \begin{matrix}\vert & [ {D}^{*} ] & & & \vert \\ \vert & & [ {D}^{*} ] & & \vert \\ \vert & & & [ {D}^{*} ] & \vert\end{matrix} & ( 52 )\end{matrix}$$

From this factorization, equations can be formulated that are used by the matrix separator 100 to determine the values of the elements in the matrices [C]. This is done on a submatrix by submatrix basis. The [D] matrices are diagonal. A quotient [U]/[L] can be substituted for each of the [D] matrices. A block transform matrix with nonzero block [F] only on the principal block diagonal can then be used to transform the coefficient matrix to a block banded form. The coefficient matrix transformer 120 performs the calculations required to transform the coefficient matrix. Once transformed, the rows and columns can be rearranged by the transformed coefficient matrix alterer 124 to change the block banded coefficient matrix into a single banded coefficient matrix that can be solved by any of the above methods.

A pre-conditioned system of equations can be efficiently solved with the disclosed methods. Among the pre-conditioners that are compatible with the disclosed methods are banded circulant and banded Toeplitz pre-conditioners. Improving the conditioning of a [T] matrix permits the disclosed methods to run faster, and with increased accuracy.

The disclosed methods can be used to solve a system of equations with an approximate Toeplitz or an approximate block Toeplitz coefficient matrix. Many devices require the solution of a system of equations with a coefficient matrix that is some type of covariance matrix. This covariance matrix is usually an approximate Toeplitz or approximate block Toeplitz coefficient matrix.

A solution to the system of equations with a covariance coefficient matrix [TO] can be obtained by approximating the covariance coefficient matrix with an approximate coefficient matrix [Tapp]. If the approximate coefficient matrix [Tapp] is a sufficient approximation to the covariance coefficient matrix [T0], the solution to the system of equations with the approximate coefficient matrix [Tapp] can be used as the solution to the system of equations with the covariance coefficient matrix.

If the approximate coefficient matrix [Tapp] is an insufficient approximation to the covariance coefficient matrix [T0], the solution to the system of equations with the approximate coefficient matrix [Tapp] can be used to determine the solution to the system of equations with the covariance coefficient matrix through iterative methods used by the expander.

There are a number of methods that can be used to approximate a covariance matrix with a Toeplitz matrix, [T]. These methods can use any statistical quantity to determine the value of the elements on a diagonal of a Toeplitz matrix from the elements on a corresponding diagonal of a covariance matrix. Once a Toeplitz matrix [T] is calculated, an approximate Toeplitz coefficient matrix [Tapp] is formed and an approximate solution is obtained as disclosed above.

The disclosed methods can be implemented using standard software languages. The algorithms can be executed on any hardware platform comprising digital circuits, including but not limited to a, general purpose microprocessor, digital signal processor DSP, application specific integrated circuit ASIC, field programmable gate array FPGA, programmable array logic PAL, or programmable logic array PLA. Storage can be any suitable data carrier known in the art. The disclosed methods are very efficient when implemented on device components that comprise parallel processing architectures.

The matrix alterer 122 can alter an element independently of other elements, rearrange a row and column independently of the other rows and columns, and calculate each of the elements in the sum of matrix products independently of each other. If the transformed coefficient matrix [Tt] is real, the separator 134 can perform two independent separation operations at the same time.

The substituter 136 can process the transformed vector and the columns of the transformed component matrix with the same instructions issued at the same time. The second vector transformer 140 can process the transformed solution vector, and the transformed component matrix, with the same instructions issued at the same time.

The disclosed device components use algorithms that perform FFTs, forward and backward substitution of upper and lower banded matrices with a column vector, complex matrix multiplication, and matrix decomposition into upper and lower banded matrices. Parallel processing hardware has been disclosed in the prior art that performs these functions with increased efficiency.

The disclosed methods can be used in control devices that have a feedback component. In these devices, a control signal is generated to control a component. An output signal from the component is sampled and the sampled output is compared to a desired component output signal. The difference between the sampled and desired output signals is then used to update the control signal. A system of equations with a Toeplitz or block Toeplitz coefficient matrix usually must be solved to update the control signal.

Imaging devices can require the solution of a system of equations with a Toeplitz or block Toeplitz coefficient matrix. These devices include magnetic resonance imaging MRI, computer tomography CT and positron emission tomography PET machines. Sensing devices like radar and sonar systems often rely on beamforming for their operation. Beamforming often requires the solution of a system of equations with an approximately Toeplitz coefficient matrix for their operation.

Many communications devices require the solution of a system of equations with an approximately Toeplitz or an approximately block Toeplitz coefficient matrix. These devices can be used for carrier frequency correction, speech encoding, communications channel estimation, mitigating intersymbol interference, the cancellation of echo and noise, channel equalization, and user detection.

Other terms with the same or similar meaning to terms used in this disclosure can be used in place of those terms used in this disclosure. Changes can be made to the form and function of any of the disclosed matrices as long as the changes do not significantly affect the accuracy or efficiency of the methods. Examples of such changes include, but are not limited to, changing from diagonal matrices to diagonally dominant matrices, changing from a matrix with nonzero elements only on a principal diagonal to a matrix with nonzero elements only on non-principal diagonals, changing from a banded matrix to a band dominant matrix, and adding rows and columns to any matrix. Any matrix can be factored into a different form by any efficient transform that separates, or forms a product with, any of the disclosed matrices.

For the purposes of this disclosure, a band dominant matrix is a matrix with the sum of the magnitudes of the banded elements being greater than the sum of the magnitudes of the out-of-band elements for each row of the matrix.

The product of i matrices [Lni] is designated by the following expression.

$$[ {\prod }^{i} Lni ] \qquad ( 53 )$$

The product of matrices [L1i] is a matrix [TL]. The product of matrices [L2i] is a matrix [TR].

The matrices [Ci] are not required to be circulant. The expansion functions for the diagonals of the [Uni] and [Lni] matrices are not limited to being sine and cosine functions. The [Ci] matrices can be any matrices that are placed in a desirable form by the same selected transform that transforms the [Uni] and [Lni] matrices to a desirable form. This selected transform is not required to be any type of Fourier transform.

The transform matrices can also be viewed as preconditioners for methods that solve banded systems of equations. Products of more than two matrices can be represented as a single matrix. The sum of multiple matrices can be expressed as a single matrix. A banded matrix is a type of band dominant matrix in this disclosure.

The number and arrangement of the components can be varied. The processor may be implemented as a combination of hardware and software components.

1. A method of calculating, on a device comprising digital circuits, an unknown solution vector X in a system of equations with a known coefficient matrix T and a known vector Y, the method comprising:
calculating a plurality of matrices C from said known coefficient matrix T and a plurality of matrices D, wherein each of said plurality of matrices D comprises a quotient of one of a plurality of upper matrices U divided by one of a plurality of lower matrices L;
calculating a plurality of transformed matrices Ct from a product comprising a matrix F and each of said plurality of matrices C;
calculating a transformed known vector Yt from a product comprising a matrix TL, said matrix F, and said known vector Y;
calculating a matrix Ttapp from a product comprising a matrix F, said matrix TL, said known coefficient matrix T, a matrix TR, and an inverse of said matrix F;
calculating a transformed unknown solution vector Xt from elements contained in said matrix Ttapp and from elements contained in said transformed known vector Yt;
calculating an unknown solution vector X from a product comprising said matrix TR, said inverse of said matrix F, and said transformed unknown solution vector Xt;
wherein said unknown solution vector X is required for operation of said device; and
wherein said device is one of a communications device for carrier frequency correction, speech encoding, communications channel estimation, mitigating inter-symbol interference, cancellation of echo and noise, channel equalization and user detection, an imaging device for magnetic resonance imaging, computer tomography and positron emission tomoqraphy, a sensing device including radar and sonar devices for beam forming, and a control device for generating a control signal.

2. A method as recited in claim 1, further comprising increasing dimensions of said known coefficient matrix T before calculating said plurality of matrices C.

3. A method as recited in claim 1, wherein:
said matrix TL is calculated by a product of matrices that form a first subset of said plurality of lower matrices L; and
said matrix TR is calculated by a product of matrices that form a second subset of said plurality of lower matrices L.

4. A method as recited in claim 3, wherein products of said matrix F, each of said upper matrices U, and said inverse of said matrix F, are banded.

5. A device comprising digital circuits for calculating an unknown solution vector X in a system of equations with a known coefficient matrix T and a known vector Y, said device comprising:
a first vector transformer for calculating a transformed known vector Yt from said known vector Y;
a second vector transformer for calculating said unknown solution vector X from a transformed unknown solution vector Xt;
a system solver for calculating said transformed unknown solution vector Xt from elements contained in a matrix Ttapp, and from elements contained in said transformed known vector Yt;
a matrix separator for calculating a plurality of matrices C from said coefficient matrix T, and for calculating a plurality of transformed matrices Ct by calculating matrix products that comprise a transform matrix F and each of said plurality of matrices C; and
a coefficient matrix transformer for calculating said matrix Ttapp from said plurality of transformed matrices Ct; and
wherein said device is one of a communications device for carrier frequency correction, speech encoding, communications channel estimation, mitigating inter-symbol interference, cancellation of echo and noise, channel equalization and user detection, an imaging device for magnetic resonance imaging, computer tomography, and positron emission tomography, a sensing device including radar and sonar devices for beam forming, and a control device for generating a control signal.

6. A device as recited in claim 5, wherein:
said matrix separator is adapted to separate said known coefficient matrix T into a sum of components comprising said plurality of matrices C, and a plurality of diagonal matrices D; and,
each of said plurality of diagonal matrices D comprises a quotient of one of a plurality of upper matrices U divided by one of a plurality of lower matrices L.

7. A device as recited in claim 6, wherein elements on a principal diagonal of each of said plurality of diagonal matrices D are determined from other elements on said principal diagonal by a recursion relationship.

8. A device as recited in claim 6, wherein:
a plurality of transformed upper matrices Ut are each calculated by a product comprising said transform matrix F, and one of said plurality of upper matrices U; and
said coefficient matrix transformer for calculating said matrix Ttapp calculates a sum of matrix products comprising said plurality of transformed matrices Ct, and said plurality of transformed upper matrices Ut.

9. A device as recited in claim 5, wherein:
said first vector transformer further comprises a vector padder for inserting zeroes in said known vector Y;
said coefficient matrix transformer further comprises a coefficient matrix alterer; and
a pad/modified vector solver calculates elements in a pad vector Sp, and a modified vector Sm.

10. A device as recited in claim 6, wherein:
elements on a principal diagonal of each of said plurality of upper matrices U are approximated by a sum of terms comprising a first set of weight constants, and a first set of expansion functions; and
elements on a principal diagonal of each of said plurality of lower matrices L are approximated by a sum of terms comprising a second set of weight constants, and a second set of expansion functions.

11. A device as recited in claim 5, wherein said coefficient matrix transformer further comprises a transformed coefficient matrix alterer for placing said matrix Ttapp in a banded form.

12. A device as recited in claim 5, further comprising an expander for calculating an iterative refinement to said unknown solution vector X.

13. A device as recited in claim 6, wherein said plurality of upper matrices U and said plurality of lower matrices L have elements whose values are constant for any said known coefficient matrix T.

14. A device as recited in claim 5, further comprising:
a difference calculator for calculating a difference coefficient matrix t, and for calculating a difference vector y;
a product adder comprising means for calculating a sum of matrix products that comprise said unknown solution vector X, said difference coefficient matrix t, and said difference vector v; and
a substituter comprising means for calculating a transformed base solution vector Xtb from said difference vector V, said difference coefficient matrix t, said unknown solution vector X, and said matrix Ttapp.

15. (canceled)

16. A method of calculating, on a device comprising digital circuits, an unknown solution vector X in a system of equations with a known coefficient matrix T and a known vector Y, said unknown solution vector X being required for the operation of said device, the method comprising:
calculating a plurality of matrices C from said known coefficient matrix T and a plurality of diagonal matrices D;
calculating a plurality of transformed matrices Ct from a product comprising a matrix F and each of said plurality of matrices C;
calculating a transformed known vector Yt from a product comprising a matrix TL, said matrix F, and said known vector Y;
calculating a matrix Ttapp from a product comprising a matrix F, said matrix TL, said known coefficient matrix T, a matrix TR, and an inverse of said matrix F;
calculating a transformed unknown solution vector Xt from elements contained in said matrix Ttapp and from elements contained in said transformed known vector Yt;
calculating an unknown vector Xyr from a product comprising said matrix TR, said inverse of said matrix F, and said transformed unknown solution vector Xt;
calculating said unknown solution vector X from said unknown vector Xyr and a vector Xr, and
wherein said device is one of a communications device for carrier frequency correction, speech encoding, communications channel estimation, mitigating inter-symbol interference, cancellation of echo and noise, channel equalization and user detection, an imaging device for magnetic resonance imaging, computer tomography and positron emission tomography, a sensing device including radar and sonar devices for beam forming, and a control device for generating a control signal.

17. A method as recited in claim 1, wherein said device comprises parallel processing computer hardware architectures.

18. A device as recited in claim 5, wherein said device comprises parallel processing computer hardware architectures.

19. A method as recited in claim 16, wherein said device comprises parallel processing computer hardware architectures.
